(19) United States
(12) Patent Application Publication
(10) Pub. No.: US 2024/0342046 A1
(43) Pub. Date: Oct. 17, 2024

(54) WEARABLE PNEUMATIC COMPRESSION APPARATUS

(71) Applicant: Arnold Tobin, Springfield Gardens, NY (US)

(72) Inventor: Arnold Tobin, Springfield Gardens, NY (US)

(21) Appl. No.: 18/622,863

(22) Filed: Mar. 29, 2024

Related U.S. Application Data
(60) Provisional application No. 63/455,876, filed on Mar. 30, 2023.
(60) Provisional application No. 63/604,160, filed on Nov. 29, 2023.

(51) Int. Cl. A61H 9/00

(52) U.S. Cl. CPC A61H 9/0078; A61H 2201/0115; A61H 2201/0207; A61H 2201/0214; A61H 2201/10; A61H 2201/1604; A61H 2201/1635; A61H 2201/164; A61H 2201/165; A61H 2201/5015; A61H 2201/5038

(57) ABSTRACT

The present invention pertains to pneumatic compression articles that implement air-based inflation technology through a built-in network of air bladders. The pressure generated through pneumatic inflation creates adjustable and controlled resistance in addition to the benefits of traditional compression. The network of individual air cells that line the interior of the articles are inflated to create a combination of compression and resistance. This results in vasodilation and more blood flow, thereby promoting an increase in healing stressed or damaged tissue and eliminate soft tissue injury and to help promote the production of collagen production. Features enabling ischemic preconditioning, cryotherapy, and thermotherapy are also implemented. The present invention may also be incorporated into other articles, such as pants and swimsuits.

### PRIORITY CLAIMS

This application claims the benefit of U.S. Provisional Application Ser. No. 63/455,876 filed Mar. 30, 2023. This application also claims the benefit of U.S. Provisional Application Ser. No. 63/604,160 filed Nov. 29, 2023, the contents of which are incorporated herein by reference.

### BACKGROUND OF THE INVENTION

The present invention is directed to compression technology.

Physical training in order to achieve peak athletic performance is dependent on optimal circulation, specifically, how much blood reaches muscular tissue. Insufficient blood flow results in reduced oxygen and nutrient delivery and is a key factor that can limit exercise duration and intensity. There is an infinite demand for enhancing traditional training and athletic performance methods, as well as achieving optimal and efficient physical recovery, in all levels of athleticism and physical ability. Recent developments pertaining to ischemic preconditioning and remote ischemic conditioning have shown significant potential as solutions to enhance maximal performance in physical activity.

Ischemic preconditioning is a method for producing resistance to the loss of blood supply, and thus oxygen, to bodily tissue. This is a non-invasive technique, involving repeated episodes of muscle ischemia followed by reperfusion at rest, in order to induce transient peripheral hypoxia and acutely improve maximal exercise capacity. Remote ischemic preconditioning is a method that aims to reduce the severity of ischemic injury to an organ by triggering the body's natural protection against tissue injury. This is done through repeated, temporary cessation of blood flow to a limb to create ischemia a lack of oxygen and glucose (ischemia) in the tissue, thereby activating the body's natural protective physiology against reperfusion injury and the tissue damage caused by low oxygen levels. Remote ischemic preconditioning essentially mimics the cardio-protective effects of exercise, in which the stimulus is distant from the organ being protected.

In addition to maximizing athletic performance, the process can make skin cells more resilient to stress, thereby slowing the aging process. Currently, and microdermabrasion devices are commonly used to promote collagen production, but many individuals are hesitant about the abrasiveness of the process and desire an alternative. Oxygen facials and pneumatic surface compression apparatuses have a myriad of skin benefits, relating particularly to blood flow and circulation and could be used as a potential alternative to micro-needling as they offer unique healing properties.

The identification of ischemic preconditioning as a means of enhancing athletic performance and as a skin treatment results in the need for implementing this concept in an efficient and convenient way.

### SUMMARY OF THE INVENTION

The present invention pertains to a pneumatic surface compression apparatus, including by way of example and not limitation, a sleeve and mask that implements air-based inflation technology. The surface compression apparatus features a built-in network of air bladders that are pumped with airflow from an inlet valve that allow air to flow through a pump chamber.

An iteration wherein the surface compression apparatus, sleeve, brace, mask, or general garment can be adjusted on a limp or appendage is supported. Moreover, an iteration where it is placed atop and strapped down by way of secure Velcro, an elastic, or other connection material is also supported. Pressure generated through pneumatic inflation creates adjustable and controlled resistance for the anatomical use and benefit of traditional compression. The network of individual air cells that line the interior of the surface compression apparatus, sleeve and or mask are inflated to create a combination of compression and resistance. This results in vasodilation and more blood flow, thereby promoting an increase in healing stressed or damaged tissue and eliminate soft tissue injury. The compression from the face mask may be an alternative to micro needling, with the compression from the pneumatic mask executing a puncturing effect.

The present invention may act as a vasodilator, which is the widening of blood vessels. It results from relaxation of smooth muscle cells within the vessel walls, in particular in the large veins, large arteries, and smaller arterioles. When blood vessels dilate, the flow of blood is increased due to a decrease in vascular resistance. The primary function of vasodilation is to increase blood flow in the body to tissues that need it most. The use of the present invention with exclusive vasoconstriction helps create a tamponade effect and control bleeding from wounded vessels that are harmed as a result of combat, or even general maim and injury.

The present invention may be worn on many parts of the body, including calf, knee, back, shoulder, arm, wrist, or hand, and is able to reduce excessive extracellular fluid, which can also be considered edema. Edema occurs when an excessive volume of fluid accumulates in the tissues, either within cells (cellular edema) or within the collagen-mucopolysaccharide matrix distributed in the interstitial spaces (interstitial edema). The present invention can decrease extracellular fluid when worn on an appendage such as the arm, thereby making the arm lighter and increasing case of movement and muscle performance during exercise.

The present invention incorporates remote ischemic preconditioning through the combination of resistance and compression, which temporarily reduces the blood flow to a tissue and causes protective molecules to be released into the bloodstream through a surface compression apparatus. Remote ischemic preconditioning may cause vessels to dilate once blood starts flowing again, increasing nutrient and oxygen delivery to the formerly deprived tissue. Remote ischemic preconditioning has been shown to stimulate the neuronal pathway (which stimulates the vagus nerve), the humoral pathway, and the systemic pathway, thereby creating an anti-inflammatory response. The application of remote ischemic preconditioning may be used to enhance maximal performance in physical activity. The garment may also have an iteration that can be worn during water sports, such as, by way of example and not limitation, swimming, surfing, etc. The pressure required to pump the pneumatic system may also help with buoyancy in the water and prevent drowning and can be used as a life vest. Additional embodiments of the garment feature RFID tracking and near-field communication protocols to help monitor and track a variety of athletic data as well as location data.

In one example of the present invention, the ischemic preconditioning can be used for a compression sock. This helps maintain warmth but also prevent impairments such as Deep Vein Thrombosis (DVP) by generating increased circulation. Additionally, one iteration may involve a modified shoe or shoe sole to accommodate the various gaits and feet of individuals. One leg compression apparatus may, in turn, extend to the foot as per the recommendation of a trained professional and one may not. In all embodiments, it should be recognized that garment coverage may extend to the feet based on the requirements of the individual.

The present invention may incorporate thermotherapy through the application of heat for the purpose of changing the cutaneous, intra-articular and core temperature of soft tissue with the intention of improving the symptoms of certain conditions, specifically to alleviate acute or chronic pain related to muscle tension, cramps, inflammation or swelling. The application of heat results in an increase in the blood flow to the skin by widening the blood vessels, providing an increased supply of oxygen and nutrients to the tissue. Muscular tissue becomes more elastic and relaxed, and joint stiffness decreases. Healing is accelerated and inflammation and swelling are reduced.

The present invention may also incorporate cryotherapy through the application of ice for the purpose of causing local vasoconstriction, which makes the blood vessels constrict and become narrower. This helps reduce clotting, tissue bleeding, and inflammation or swelling. The application of ice is very useful when an injury first occurs. With the addition of both cryotherapy and thermotherapy along with the remote ischemic preconditioning in the present invention, muscles can be healed at a much higher rate.

The present invention can be used as a single therapy function or in different functional combinations. For example, just the remote ischemic preconditioning mode could be used when a user needs to enhance maximal performance. However, if an injury occurs, a user can use the cryotherapy function to reduce clotting and inflammation early on. Once that treatment is done, the user can use the thermotherapy function to widen the blood vessels and reduce the joint stiffness that the cryotherapy function creates. After both these functions are used, the user can then use the remote ischemic preconditioning function to enhance the maximal performance.

In one embodiment, the compression mask may be paired with red light therapy to further heighten fibroblast activity. Traditional means to boosting collagen production such as micro needling can be abrasive for some. In the present invention, the pneumatic compression therapy on the face servers as a potential alternative. Air cells implemented within the mask to create pneumatic compression aid in collagen production by compressing tissues and vessels and promoting blood flow. These air cells can come in a variety of shapes, such as, by way of example and not limitation, circular, rectangular, triangular, hexagonal, star-shaped, or octagonal among others. These air cells may also be textured and embossed with raised points, or with ribbed or dotted surfaces.

Fibroblasts help synthesize collagen, and improved blood flow, a result of pneumatic compression, helps create an environment wherein fibroblasts can function at optimized levels. The pressure pumped into the air cells of the face mask may either be generated manually by way of a handheld pump or internally compressed. In another embodiment, the process may use, by way of example and not limitation, electric micro-suction pumps which help unclog clogged pores, peristaltic pumps, or piezoelectric pumps.

Piezoelectric pumps work best in embodiments wherein an electric current or pressure and sound waves are employed. These pumps come in array of compact sizes that allow them to be integrated into a mask design in a seamless fashion. Piezoelectric micropumps can also aid in providing exact dosages of skincare products and fluids to the skin, which may be beneficial for estheticians and skincare professionals to mitigate negative chemical reactions. To operate this type of pump, tools such as an air compressor, control mechanism configured to the apparatus' microcontroller unit, various power supplies, a plurality of valves, actuators, among other control devices and sensors are needed. In addition to a central processing unit on a configurable device for diagnostics, distribution and monitoring are also vital to execute an instruction to operate a pump.

These piezoelectric pumps may also be configured to a remote device and be customizable by a skincare professional allowing for these professionals to cater to their clientele's skincare needs more specifically. Because these pumps can provide exact dosages of products with their valve operation, there is minimal contamination interfering with the delivery of such fluids. One potential deficiency of piezoelectric pumps can be that they require electricity and voltage to operate their electrical and mechanical systems. In another alternative embodiment, an air-powered miniature vacuum pump may be employed.

In an additional embodiment, red light therapy is also incorporated within the pneumatic face mask, to further enhance the fibroblast activity. The mask may even use blue light therapy, or blue light and red-light therapy in unison. Blue light therapy is often used as an anti-bacterial treatment to help combat and prevent acne and bacteria from entering the epidermis.

The present invention includes an electronic pump mechanism that is built into the sleeve and or mask, allowing for a built-in control of the inflation and deflation of the air cells.

In another embodiment, the present invention may incorporate an external electronic pump mechanism to inflate and deflate the network of interconnected air cells within the interior of the sleeve and or mask. The external pump mechanism is connected to the sleeve or mask through a hose that is attached to an intake valve on the sleeve or mask.

In another embodiment, the mask may also employ micro-probes, pads, wands, rollers, or built in electrodes to electronically stimulate the skin of a user using microcurrent therapy with low-level currents.

The present invention may incorporate a manual pump mechanism to inflate and deflate the air cells. The manual pump is connected to the sleeve or mask and when compressed, the network of interconnected air cells within the sleeve or mask inflates and deflates. Another aspect of the manual pump is the use of an actuator that is wound prior to use. The user can wind the manual pump for a desired amount of time, providing the user control of inflating and deflating the air cells while wearing the sleeve or donning the mask.

One iteration of the mask includes the injection of various fluids. Some injectables that can be secreted from the mask include snail mucin, various vitamins such as vitamin C, collagen, biotin, retinols, vitamin A, niacinamides, and other skincare serums that help enhance the look of skin.

Another quality of the present invention is that there might be vibration therapies implemented around the proximity of the air cells in order to stimulate the skin. Other vibrations, such as ultrasonic vibrations, may be utilized in the mask as well to massage the skin, help with product penetration, and even serve as a separate skincare treatment. Sound waves and frequencies, usually between 20,000 to 30,000 Hertz are ideal for skincare. The vibrations generated from these waves can help remove dead skin cells and promote turnover in skin cells by exfoliating the upper layer of the dermis, as well as lift and firm the skin. Likewise, these vibrations can also treat inflammation and when paired with blue-light treatments they can have anti-bacterial and anti-fungal properties.

Cryotherapy may be implemented in further embodiments of the present invention. For the purpose of skincare, cold therapy tightens pores, enhances the skin and encourages blood circulation which benefits the complexion by way of essential nutrients. Cold therapy can also help areas with acne, sunburn or general redness and help soothe irritated skin.

For the purpose of physical therapy, the cold therapy garment may be utilized on a variety of pain areas such as the knees, shoulders, neck, arms, legs, feet, back, or any other appendage wherein the garment may be able to surround the dermis. Cold therapy works by constricting the blood cells and reduce blood flow where it is applied. This, in turn, has benefits such as a reduction in pain or swelling as a result of injuries. Vasoconstriction can protect tissues surrounding injured areas and also minimize bleeding, as swelling tends to result in the compression of nerves and blood vessels which further cause harm.

The gelid nature of the compression wrap also numbs the area it is applied to and reduces nerve activity and function as an applied anti-inflammatory, which aids in mitigating pain. This is beneficial for not only injuries but conditions such as arthritis. Another instance where the cold therapy compression garment can be used is after a workout. Athletes can mitigate pain and manage their muscle soreness by applying the cold compression garment in the affected areas.

An additional embodiment of the present invention features air cell compression employed as a pressure dressing for hemostatic pressure or hemorrhage control. This iteration of the present invention can be used to dress a wound, such as wounds acquired in combat or from general harm or maim.

The garment itself can come in the form of sleeves, tights, shirts, vests, gloves, shorts, stockings, wraps, casts, masks, shoes, socks, compression socks, and all other garment pieces that may house cold therapy technology in addition to all the aforementioned aspects. Compression socks with air cells may also help individuals size up in shoe size, and insertable air cells within shoes may make larger shoe sizes fit more appropriately.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The various embodiments are illustrated by way of example, and not by way of limitation, in the figures of the accompanying drawings. Having thus described the invention in general terms, reference will now be made to the accompanying drawings, which are not necessarily drawn to scale, and wherein:

FIGS. 1A-D are images of the sleeve and internal air cells.

FIG. 2 is diagram of the air pump mechanism of the present invention.

FIG. 3 is a flow diagram of the pneumatic microcontroller unit of the present invention.

FIG. 4 is a diagram of remote ischemic preconditioning as applied to the present invention.

FIG. 5 is a diagram of the air valve connectivity of the present invention.

FIGS. 6A-C are diagrams of the three types of pump options.

FIG. 7 is a diagram of the electronic type of pump.

FIG. 8 is a diagram of the external type of pump.

FIG. 9 is a diagram of the manual type of pump.

FIGS. 10A-D are images of the present invention worn as a pant variation.

FIG. 11 is a depiction of the present invention's air valve pneumatic mechanism applied to a mask.

FIG. 12 are images of the mask and internal air cells.

FIG. 13 is an exemplary embodiment of the present invention's inflatable insole.

### DETAILED DESCRIPTION OF THE PREFERRED EMBODIMENT

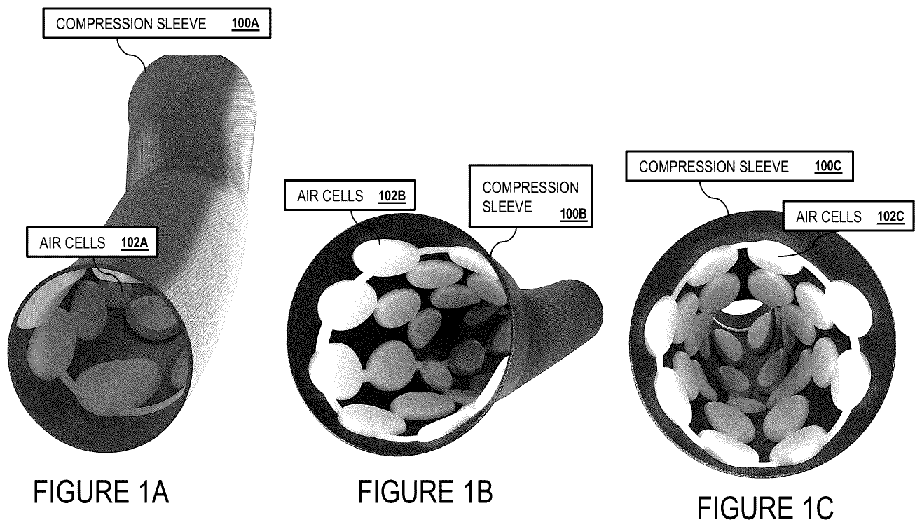

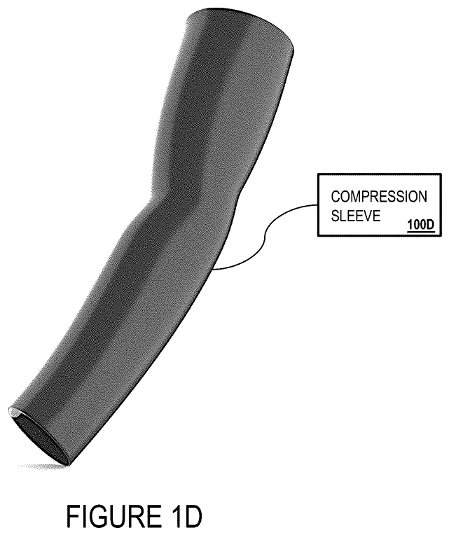

FIGS. 1A-D are images of an example sleeve featuring the surface compression apparatus, comprising of a plurality of internal air cells. The surface compression apparatus itself enables individualized control of each air cell via a user's processing device. An iteration wherein the surface compression apparatus, sleeve, brace, mask, or general garment can be adjusted on a limp or appendage is available. The pneumatic surface compression sleeve described herein implements air-based inflation technology through a built-in network of air bladders or air cells for anatomical use. The “network” of air bladders operates internally, and as such, the surface compression apparatus may be wrapped around, or configured in a plethora of fittings for various anatomical uses. In accordance with the preferred embodiment of the present invention, FIG. 1A shows a front facing view of the compression sleeve 100A and internal network of air cells 102A. FIG. 1B shows an internal front facing view of the network of air cells 102B of the interior perimeter of the sleeved, surface compression apparatus 100B. FIG. 1C shows the internal sleeve 100C and network of air cells 102C. The pressure generated through pneumatic inflation creates adjustable and controlled resistance in addition to the benefits of traditional compression. Moreover, the pressure can be used to help wounds that have been acquired in combat or from general maim or harm to prevent hemorrhaging. The network of individual air cells that line the interior of the sleeve are inflated to create a combination of compression and resistance. This results in vasodilation and more blood flow, thereby promoting an increase in healing stressed or damaged tissue and eliminate soft tissue injury. FIG. 1D shows the external view of the pneumatic compression sleeve 100D.

The present invention may be worn and adjusted on the arm or wrist, and is able to reduce excessive extracellular fluid, which can also be considered edema. Edema occurs when an excessive volume of fluid accumulates in the tissues, either within cells (cellular edema) or within the collagen-mucopolysaccharide matrix distributed in the interstitial spaces (interstitial edema). The present invention can decrease extracellular fluid when worn on an appendage such as the arm, thereby making the arm lighter and increasing case of movement and muscle performance during exercise.

In one embodiment, the present invention includes an electronic pump mechanism that is built into the sleeve, allowing for a built-in control of the inflation and deflation of the air cells.

In another embodiment, the present invention may incorporate an external electronic pump mechanism to inflate and deflate the network of interconnected air cells within the interior of the sleeve. The external pump mechanism is connected to the sleeve through a hose that is attached to an intake valve on the sleeve.

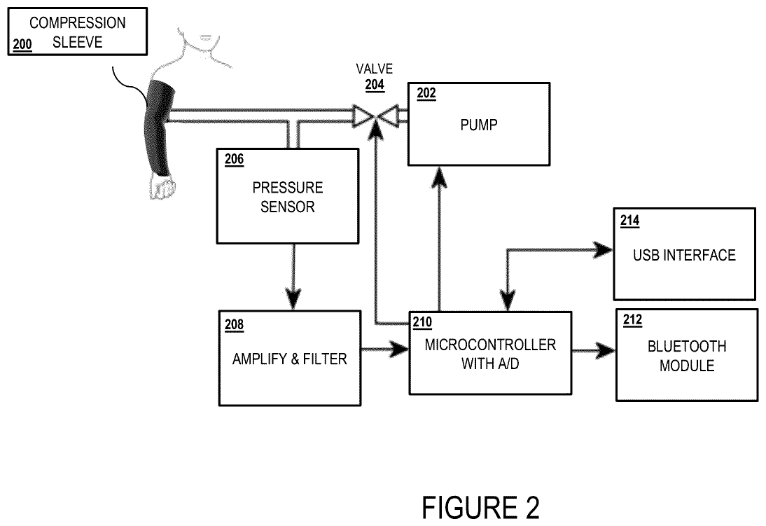

FIG. 2 is diagram of the air pump 202 mechanism of the present invention. In accordance with the preferred embodiment, air is pumped into the pneumatic compression sleeve 200 by way of a built-in intake valve 204. The pneumatic compression sleeve 200 is connected to a pressure sensor 206, amplifier, and filter 208 which in turn is connected to a microcontroller 210 with analog to digital conversion capability. The microcontroller 210 may also connect to a USB interface 212 module or Bluetooth module 214, to enable both wired and wireless exchange of data, such as pressure data, recovery data, and operate external controls of the pneumatic compression sleeve.

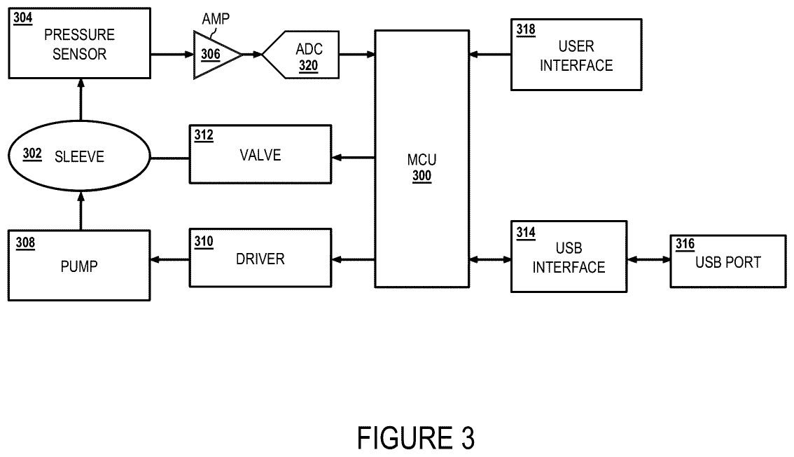

FIG. 3 is a flow diagram of the pneumatic microcontroller unit 300 of the present invention. In accordance with the preferred embodiment, the microcontroller unit 300 of the pneumatic pump 300 mechanism controls the driver 310 which operates as a power and energy supply in order to inflate or deflate the sleeve 302 by way of the pump 308. The sleeve 302 is also connected to a valve 312, which comprise of an inlet and outlet valve, and contain a pressure sensor 304 for the internal air cells. The pressure sensor 302 is connected to an amplifier 306 and analog to digital converter 320 which connects back to the microcontroller unit 300. The microcontroller unit 300 may have a built-in user interface 318 to operate the device and may also connect to an external USB interface 314 and USB port 316.

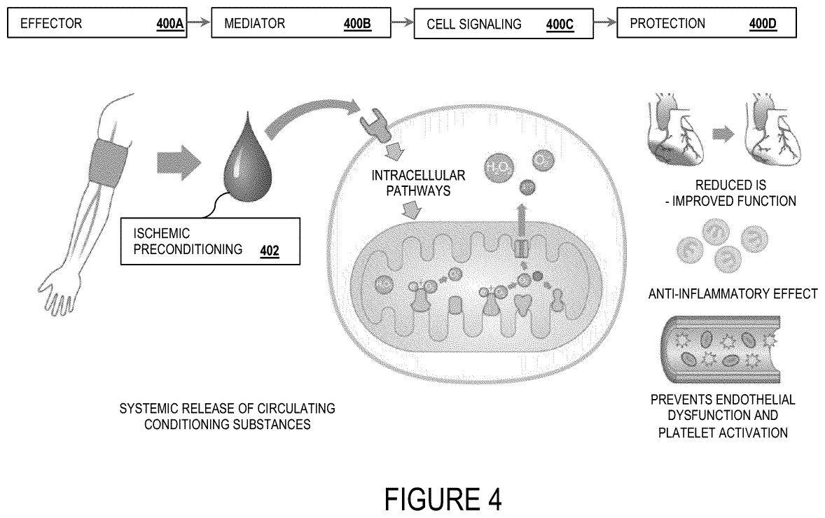

FIG. 4 is a diagram of remote ischemic preconditioning 402 as applied to the present invention. In accordance with the preferred embodiment, the pneumatic compression sleeve acts as an effector 400a, mediator 400b, whereby the compression and resistance from the inflated air cells causes the systematic release of circulating conditioning substances, and creating a cell-signaling 400c response within the intracellular pathways. This results in a cardio-protective effect 400d, an anti-inflammatory effect and prevents endothelial dysfunction and platelet activation.

The present invention incorporates remote ischemic preconditioning 402 through the combination of resistance and compression, which temporarily reduces the blood flow to a tissue and causes protective molecules to be released into the bloodstream. Remote ischemic preconditioning 402 may cause vessels to dilate once blood starts flowing again, increasing nutrient and oxygen delivery to the formerly deprived tissue. Remote ischemic preconditioning has been shown to stimulate the neuronal pathway (which stimulates the vagus nerve), the humoral pathway, and the systemic pathway, thereby creating an anti-inflammatory response. The application of remote ischemic preconditioning 402 may be used to enhance maximal performance in physical activity. All flow data can be acquired through numerous sensors, such as pressure sensors, manometers and a memory unit configured to the microcontroller maintains data units regarding the apparatus' historical use. All pertinent data is presented on a display unit, typically on a user's processing device, such as a mobile phone, touchscreen tablet, desktop computer, laptop, or other operating system.

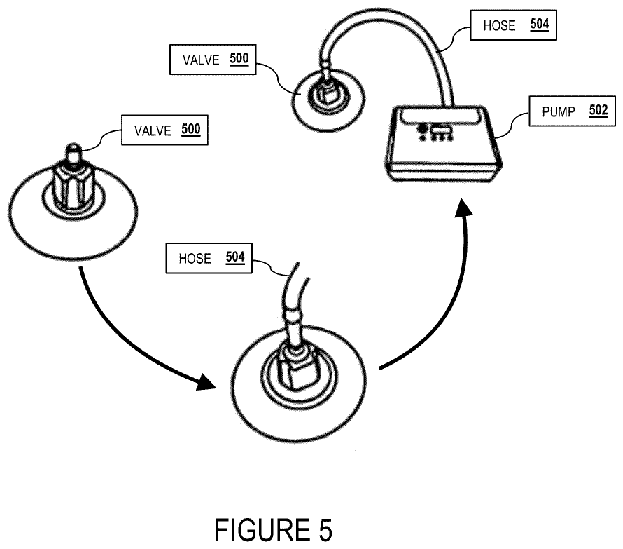

FIG. 5 is a diagram of the air valve 500 connectivity of the present invention. In one embodiment, the external pump mechanism 502 is connected to the pneumatic compression sleeve through a hose 504 that is attached to an intake air valve 500 on the sleeve.

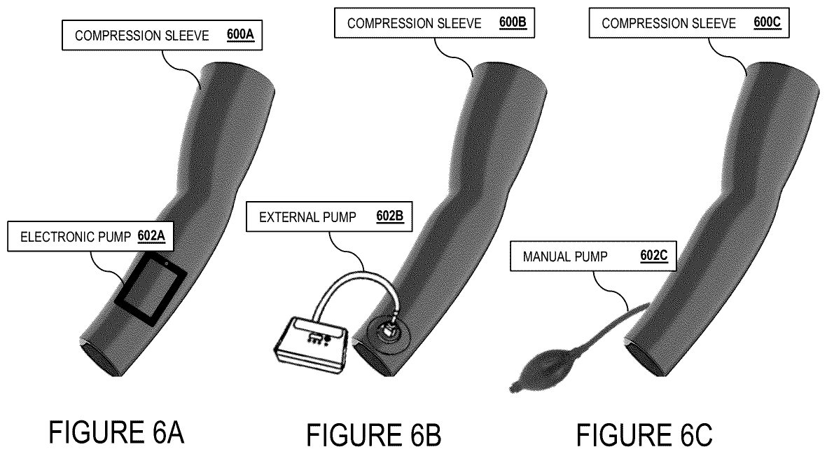

FIGS. 6A-C are diagrams of the three types of pump options. The present invention has three embodiments for the different type of pumps for the sleeve. One embodiment, as shown in FIG. 6A, is an electronic mechanism 602A that is built into the sleeve 600A. This built-in electronic pump 602A creates an automated inflation and deflation of the air cells within the sleeve. In another embodiment, as shown in FIG. 6B, the pump is external 602B, through USB or Bluetooth. In this embodiment, the air cells are inflated and deflated when the external devices turn on the pump to inject air into the sleeve 600B. In another embodiment, as shown in FIG. 6C, the inflation and deflation of the sleeve 600C is worked through a manual pump 602C. With this embodiment, the user will compress and release the pump to inflate the air cells within the sleeve.

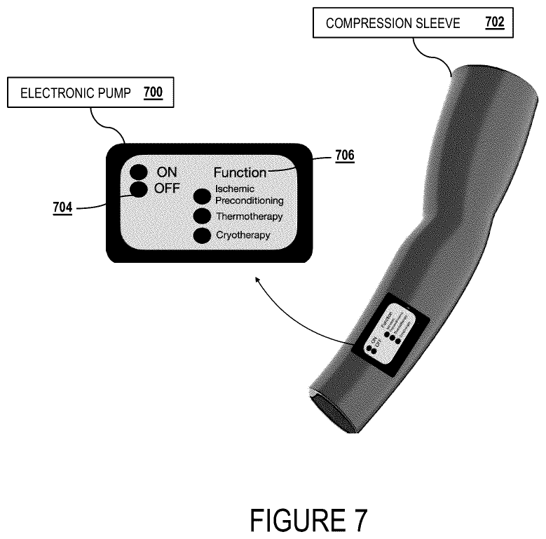

FIG. 7 is a diagram of the electronic type of pump 700. In the electronic pump 700 design, there are buttons on the sleeve 702 to control the different functions of the sleeve. Because the electronic pump is automated, once the user chooses a function, they press the button 704, and the electronic pump automatically performs the function 706. These functions are the ischemic conditioning function, thermotherapy function, and the cryotherapy function.

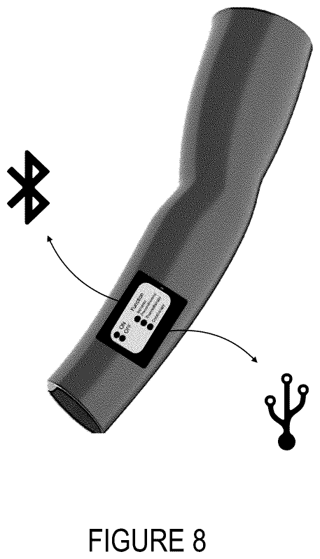

FIG. 8 is a diagram of the external type of pump. In the external pump, the pump is integrated through a USB device that is plugged into the sleeve or with Bluetooth connected to an iPhone or other device. With the use of the external pump, the user can select which function they wish to perform with the sleeve and PSI data for uses involving pneumatic pumps.

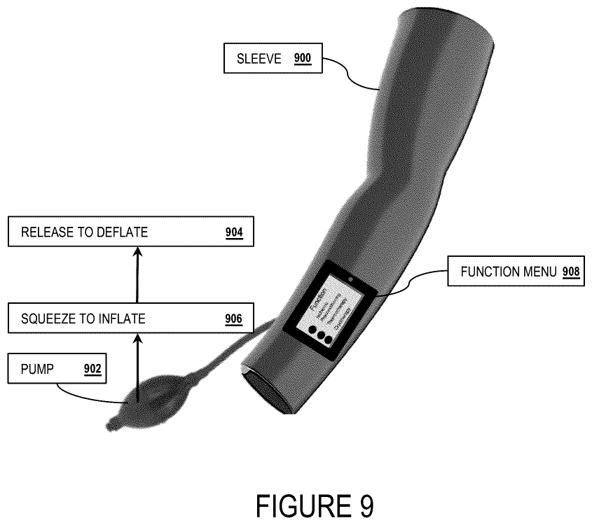

FIG. 9 is a diagram of the manual type of pump. In the manual pump, a pump is attached to the top of the sleeve 900. This pump controls the inflation and deflation of the air cells through the compressing (or squeezing) and releasing of the pump 902 by the user. This allows the user to control the inflation 906 and deflation 904 of the air cells. This pump 902 will also allow the user to choose which function 908 they would like to perform with the sleeve 900, while controlling the inflation 906 and deflation 904 of the air cells.

The present invention may act as a vasodilator, which is the widening of blood vessels. It results from relaxation of smooth muscle cells within the vessel walls, in particular in the large veins, large arteries, and smaller arterioles. When blood vessels dilate, the flow of blood is increased due to a decrease in vascular resistance. The primary function of vasodilation is to increase blood flow in the body to tissues that need it most.

The present invention may incorporate thermotherapy through the application of heat for the purpose of changing the cutaneous, intra-articular and core temperature of soft tissue with the intention of improving the symptoms of certain conditions, specifically to alleviate acute or chronic pain related to muscle tension, cramps, inflammation or swelling. The application of heat results in an increase the blood flow to the skin by widening the blood vessels, providing an increased supply of oxygen and nutrients to the tissue. Muscular tissue becomes more elastic and relaxed, and joint stiffness decrease. Healing is accelerated and inflammation and swelling are reduced.

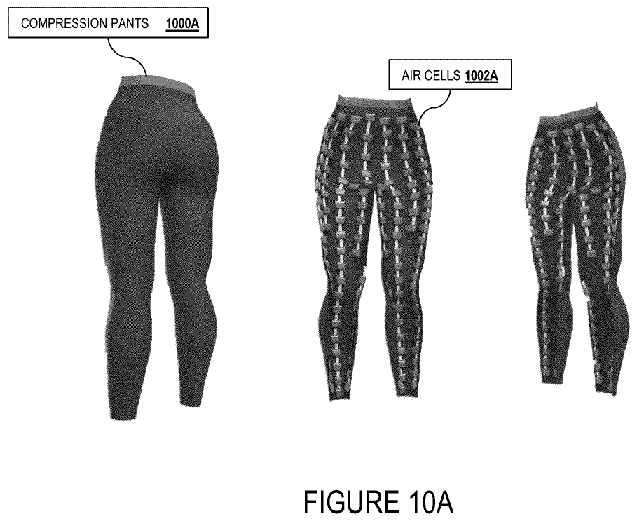

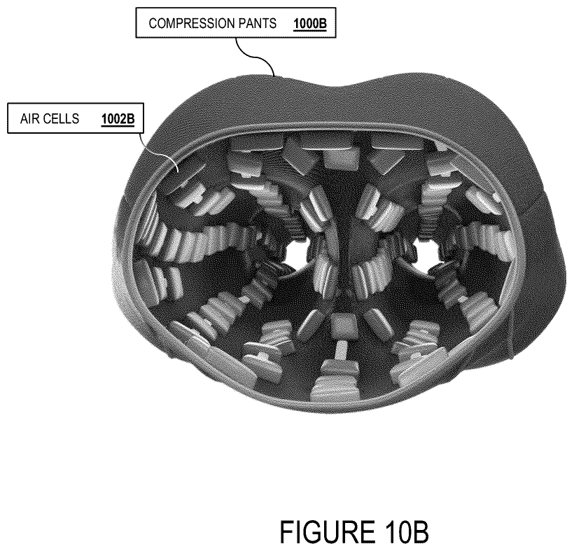

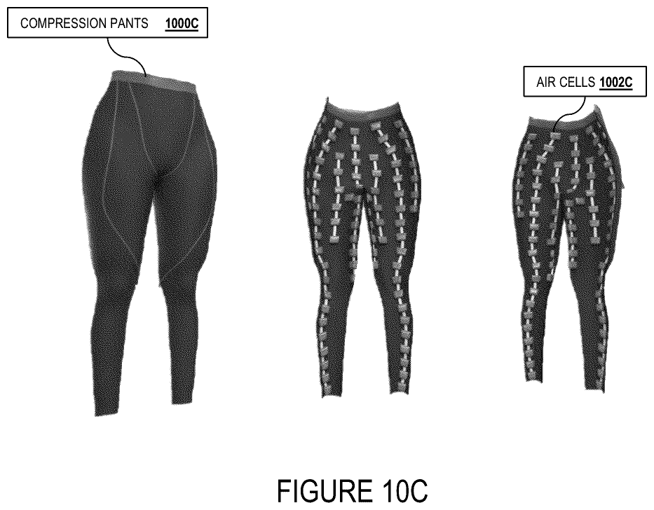

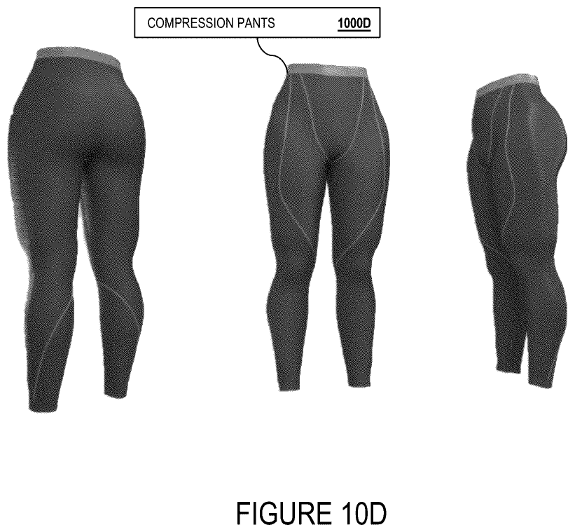

FIGS. 10A-D are images of the present invention as a pant variation. In one embodiment, compression pants and the air cells within the pants are identical to the internal cells of the present invention. FIG. 10A presents the compression pants 1000a from reverse view and the system of air cells 1002a within. FIG. 10B provides a visual representation of the air cells 1000b. FIG. 10C displays a frontside view of the compression pants 1000c and the air cells 1002c within. FIG. 10D shows the presentation of the pants 1000d from the outside. The present invention incorporates the use of the cells within the pants and sleeves for the purpose of relieving pain, tension, inflammation, and swelling.

The present invention has a “scaled” pattern featured, for the purpose of providing the user with resistance while swimming. The resistance exists to establish a functional strength element for the user, which enables the user to train and rehabilitate more efficiently than without the invention. The scales are presented in a reverse alignment and will rise to provide resistance when the user travels through water. The scales are incorporated onto gloves, arm sleeves, leg sleeves, socks, shoes, and full body suits and swimsuits and may implement RFID technology. One leg compression apparatus may, in turn, extend to the foot as per the recommendation of a trained professional and one may not. In all embodiments, it should be recognized that garment coverage may extend to the feet based on the requirements of the individual.

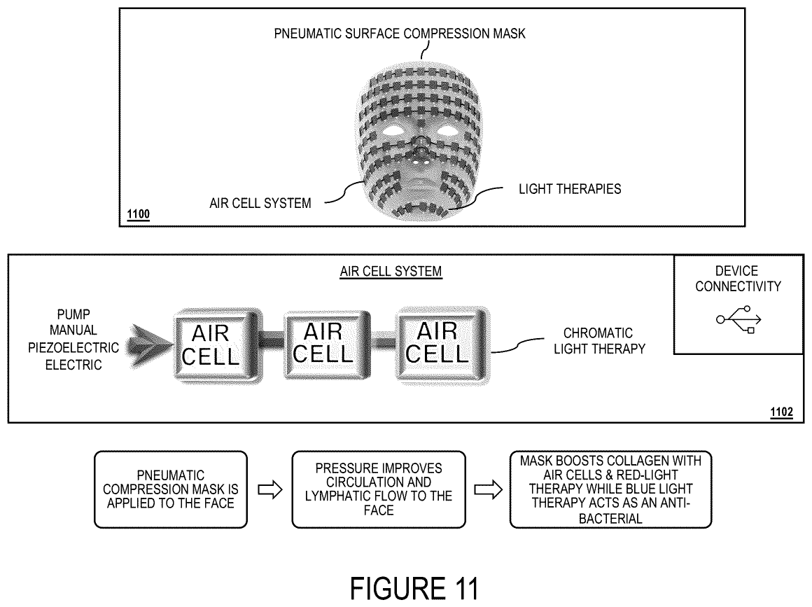

FIG. 11 is an embodiment of the present invention's pneumatic compression therapy in a face mask 1100. The pneumatic compression on the face can act as a less abrasive alternative to micro needling. The air cells within the face mask help boost collagen production by compressing tissues and vessels and promoting blood flow. This process helps support collagen production, as improved blood flow because of the pneumatic compression helps create an environment wherein fibroblasts, which help synthesize collagen, can function at peak performance. The compression can be generated either manually or internally compressed by way of a traditional pump as depicted or other smaller pumping devices. Pneumatic compression can help heal wounds and thereby reduce edema and encourage tissue regeneration. In one embodiment, chromatic light therapy, such as red light and blue light therapy is also incorporated within the perimeters of the air cell system 1102 in the pneumatic face mask, to further enhance the fibroblast activity. Moreover, in some embodiments of the present invention, the face mask is connected to a connectivity device and all pertinent data regarding treatment is transferred to a non-transitory storage medium such as a local and read only memory, in addition to cloud memory.

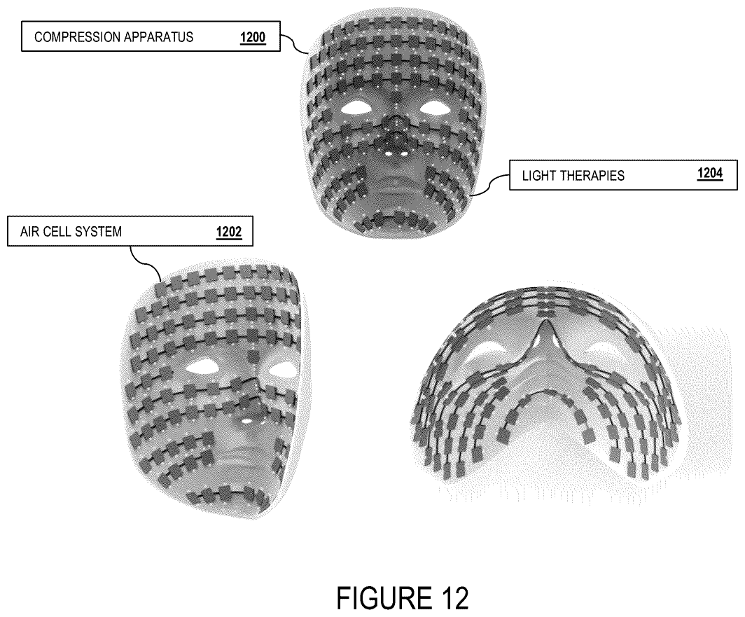

FIG. 12 are images of the compression apparatus, in the form of a mask, and internal air cells from the front, side and bottom view. The compression apparatus 1200 employ chromatic light for red light and blue light therapies 1204. The pressure generated through pneumatic inflation of the air cell system 1202 creates adjustable and controlled resistance in addition to the benefits of traditional compression. The network of individual air cells in the air cell system 1202 line the interior of the compression apparatus and are inflated to create a combination of compression and resistance to simulate micro-needling and other procedures to promote collagen production. In various embodiments, the present invention may include an electric micro-suction pump, which help unclog clogged pores, a peristaltic pump, or a piezoelectric pump, which allows for built-in control of the inflation and deflation of the air cells.

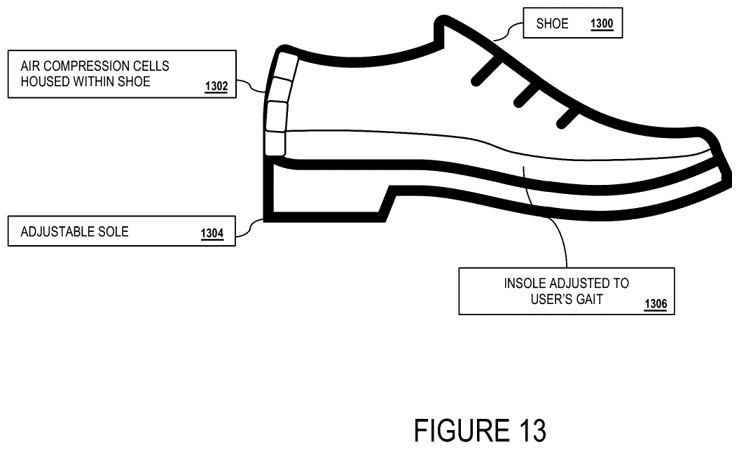

FIG. 13 is an iteration of the present invention's inflatable insole by way of air compression cells housed within the shoe 1300. In one embodiment, the sole and the insole of the shoe 1300 may be adjusted, however, either one or the other may be adjustable based on the preferences of the user. The adjustable insole 1204 allows a user to comfortably walk according to the precise shape of their feet 1306. It would also allow them to accommodate gait disturbances as a result of injury, fatigue or after athletic events. The present invention may also “massage” a wearer's foot, as the air cells 1302 are capable of being pumped and deployed at the discretion of a wearer by way of a user processing device with Bluetooth and near field communication capabilities.

While various embodiments of the disclosed technology have been described above, they have been presented by way of example only, and not of limitation. Likewise, the various diagrams may depict an example architectural or other configuration for the disclosed technology, which is done to aid in understanding the features and functionality that may be included in the disclosed technology. The disclosed technology is not restricted to the illustrated example architectures or configurations, but the desired features may be implemented using a variety of alternative architectures and configurations. Indeed, it will be apparent to one of skill in the art how alternative functional, logical, or physical partitioning and configurations may be implemented to integrate the desired features of the technology disclosed herein. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

What is claimed is:

1. A surface compression apparatus for anatomical use, comprising:
an internal network comprising of a plurality of air cells on one perimeter of said surface compression apparatus;
an air compressor, operating as a power source to enable an injection of air into said plurality of air cells;
a plurality of valves, connected to said internal network, and wherein at least one of said plurality of valves regulate a flow rate of said injection of air into said plurality of air cells;
a microcontroller unit, for retrieving an instruction from a user's processing device to manage said injection of air into said plurality of air cells with a pump according to pressure data relayed from a pressure sensor; and
a user interface, configured to said user's processing device to operate said surface compression apparatus using data transmitted from and to said microcontroller unit.

2. The surface compression apparatus of claim 1, wherein said plurality of air cells include a reverse-alignment configuration to provide resistance in aquatic environments.

3. The surface compression apparatus of claim 1, wherein said plurality of air cells are capable of individualized control through said microcontroller unit.

4. The surface compression apparatus of claim 1, wherein at least one of said plurality of valves is an intake valve, and wherein at least one of said plurality of valves is an outlet valve.

5. The surface compression apparatus of claim 1, wherein said data transmitted to from and to said microcontroller unit include pound per square inch of pressure injected into said plurality of air cells.

6. The surface compression apparatus of claim 1, wherein said internal network of said plurality of air cells is capable of being manually customized to administer said injection of air to a user-specified anatomical structure.

7. The surface compression apparatus of claim 1, wherein said pump includes an external pump, integrated with a universal serial bus connector to configure said user interface with said user's processing device.

8. A method for using a surface compression apparatus for anatomical benefit, the method comprising:
generating, by way of an air compressor, energy to execute an injection of air into a plurality of air cells;
injecting air into an internal network comprising of said plurality of air cells on one perimeter of said surface compression apparatus;
sensing pressure of said injection of air into said plurality of air cells by way of a pressure sensor on said surface compression apparatus;
retrieving an instruction from a user's processing device a microcontroller unit, for to manage said injection of air into said plurality of air cells with a pump according to pressure data relayed from said pressure sensor;
presenting a user interface, configured to said user's processing device to operate said surface compression apparatus using data transmitted from and to said microcontroller unit; and
regulating a flow rate of said injection of air into said plurality of air cells using said user interface to operate a plurality of valves, connected to said internal network comprising of said plurality of air cells.

9. The method of claim 8, wherein said plurality of air cells include a reverse-alignment configuration to provide resistance in aquatic environments.

10. The method of claim 8, wherein said plurality of air cells are capable of individualized control through said microcontroller unit.

11. The method of claim 8, wherein at least one of said plurality of valves is an intake valve, and wherein at least one of said plurality of valves is an outlet valve.

12. The method of claim 8, wherein said data transmitted to from and to said microcontroller unit include pound per square inch of pressure for said air injected into said plurality of air cells.

13. The method of claim 8, wherein said internal network of said plurality of air cells is capable of being manually customized to administer said injection of air to a user-specified anatomical structure.

14. The method of claim 8, wherein said pump includes an external pump, integrated with a universal serial bus connector to configure said user interface with said user's processing device.

15. A surface compression apparatus for anatomical use, comprising:
an internal network comprising of a plurality of air cells on one perimeter of said surface compression apparatus;
an air compressor, operating as a power source, to enable an injection of air into said plurality of air cells, and wherein said plurality of air cells include a reverse-alignment configuration to provide resistance in aquatic environments;
a plurality of valves, connected to said internal network, and wherein at least one of said plurality of valves regulate a flow rate of said injection of air into said plurality of air cells, and wherein at least one of said plurality of valves include an inlet and an outlet valve;
a microcontroller unit, for retrieving an instruction from a user's processing device to manage said injection of air into said plurality of air cells with a pump according to data relayed from a pressure sensor, including pound per square inch of pressure injected into said plurality of air cells, and wherein said plurality of air cells are capable of individualized control through said microcontroller unit; and
a user interface, configured to said user's processing device by way of a universal serial bus and connector to operate said surface compression apparatus using said data transmitted from and to said microcontroller unit, and wherein said internal network of said plurality of air cells is manually customized to administer said injection of air to a user-specified anatomical structure.

16. The surface compression apparatus of claim 15, wherein said plurality of valves prevent backflow by at least one of said plurality of valves, including a check valve.

17. The surface compression apparatus of claim 15, wherein said pump includes an external pump connected to said user's processing device by way of said universal serial bus and connector.

18. The surface compression apparatus of claim 15, wherein said microcontroller unit is connected to an amplifier and filter which toggles for ischemic preconditioning, thermotherapy and cryotherapy.

19. The surface compression apparatus of claim 18, wherein said microcontroller unit has analog to digital conversion capability.

20. The surface compression apparatus of claim 15, wherein said plurality of air cells are ringed with a chromatic light for photo biomodulation and to heighten fibroblast activity of said user-specified anatomical structure.
